(19) United States
(12) Patent Application Publication
(10) Pub. No.: US 2009/0094642 A1
(43) Pub. Date: Apr. 9, 2009

(54) COMMUNICATION DEVICE, COMMUNICATION SYSTEM AND METHOD OF PROVIDING INFORMATION TO A USER ON A DISPLAY OF A COMMUNICATION DEVICE

(75) Inventor: PAOLA M. HOBSON, ALTON (GB)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/868,738

(22) Filed: Oct. 8, 2007

(51) Int. Cl. H04N 5/455

(52) U.S. Cl. 725/37; 725/39; 725/46; 725/86

(57) ABSTRACT

A communication device (6) for operating in a communication system (2) comprises a receiver (203) for receiving information from at least one information source (2) of the communication system and a display (206) coupled to the receiver for displaying information to a user of the communication device. The communication device (6) is arranged in operation and based on the received information to display on the display (206) at predetermined times system information specified by the communication system (2) with user information based on user preference data and at other times to display the user information without the system information.

### FIELD OF THE DISCLOSURE

This disclosure relates to a communication device, a communication system and a method of providing information to a user on a display of a communication device operating in a communication system.

### BACKGROUND OF THE DISCLOSURE

Electronic Service Guides (ESG), Interactive Program Guides (IPG), Electronic Program Guides (EPG) provide information about services and programs available to a user such as service description, program content description, schedule information, acquisition methods required to access the content or service, purchase options etc. In the following the term ESG will be used to refer to EPG, IPG and ESG guides. The services and programs may include on-line newspapers, radio, and television and are organised into media streams in the form of audio, video and/or other types of data available through a variety of types of networks such as the internet, cable, satellite or radio networks.

The ESGs are usually presented to a user on a display of a terminal for selection and the user can navigate through the selected ESGs and further select one or more of the available programs and services. The programs and services may be currently available (and for example, may include archive material) or may be available in the future. The terminal may be a set top box or Personal Video Recorder (PVR) with the television operating as the display, or may be a mobile terminal such as a portable radio telephone, Person Digital Assistant (PDA) or similar device.

As the amount of information available to a user of a terminal has increased, in order to avoid users being overwhelmed by the number of available information items, personalised content delivery systems, such as that provided for mobile terminal applications in Digital Video Broadcast for Handheld devices (DVB-H), and the SCREEN3 content management system developed by Motorola, Inc., have been developed which filter information according to user preferences so that a user is presented with a personalised ESG. The personalised ESG includes a prioritised list of information items most likely to be of interest to the user.

US patent application no. 20060184558 describes a content management system in which information items are recommended to the user based on previous user activity and/or explicit user expression of preferences and interest and a knowledge base of the system which comprises collections of information items (e.g. play lists) from a community of users.

Radio network operators provide the services and content as well as the ESGs to the mobile terminals. The services and content and ESGs may be provided by the radio network operators themselves or by content providers. Since the personalised ESGs are based on user preferences, such personalised content delivery systems take away control from the network operator or content provider. In such situations, this may cause problems which the network operator or content provider would like to avoid.

For example, a user specifies preferences for information on African politics, world poverty and aviation in their user preferences. The selection of content from the available information may lead to the user being presented with a story about a plane crash involving the Nigerian Foreign Minister followed by a report from the previous day on the cessation of the use of charitable aid money for the transport industry within African countries. The positioning of these stories may lead to the unfortunate and coincidental implication that interference from foreign governments in the allocation of charitable fund has led to this new disaster. Such potential issues could be avoided by the network operator or content provider retaining some editorial control. This would mean for the specific example described above, the network operator or content provider could, as an example, insert other stories between the plane crash story and the charitable aid report.

In another example, a user specifies preferences for road cycling, roman history and 18th century French literature and thus expects to be presented with a personalised ESG which lists content and services matching these specified preferences. If the network operator or content provider also had available for delivery a program in an area of interest similar to one of the user preferences, such as the Monaco Grand Prix, according to the personalised content delivery system such a program would not be presented to the user.

In another situation when a user has very broad preferences, the user could select too many information items for the available bandwidth. In this situation, it would be desirable for the network operator to have some editorial control in selecting the information items according to the available bandwidth.

Providing information to users by way of advertisements is well known. See for example US patent application no. 20050288954 and the sponsored links that are presented on web pages obtained through search engines such as Google. However, such advertisements can be annoying to the user, in particular if they relate to services in which the user is not interested and due to the fact that they occupy display space which could be used for information in which the user is interested.

There is therefore a need for improving how information is provided to a user of a communication device in personalised content delivery systems.

### SUMMARY OF THE DISCLOSURE

In accordance with the disclosure, there is provided a communication device, a communication system, a method of providing information to a user on a display of a communication device as recited in the accompanying claims.

### BRIEF DESCRIPTION OF THE DRAWINGS

A communication device, a communication system, a method of providing information to a user on a display of a communication device, in accordance with the disclosure will now be described, by way of example only, with reference to the accompanying drawings in which:

FIG. 1 is a block schematic diagram of a communication system;

FIG. 2 is a block schematic diagram of a wireless device in accordance with an embodiment of the present disclosure; and

FIG. 3 is a simplified representation of exemplary information displayed to two users X, Y in a first mode of operation in accordance with the disclosure; and

FIG. 4 is a simplified representation of exemplary information displayed to two users X, Y in a second mode of operation in accordance with the disclosure.

### DETAILED DESCRIPTION OF THE DRAWINGS

In the following description, embodiments of the disclosure will be described with respect to a wireless device operating within one or more wireless communication networks, such as a 2nd generation cellular communication system known as the Global System for Mobile communication (GSM), a 3rd generation cellular communication system such as an Universal Mobile Telecommunication system (UMTS), or a DVB-H communication system. However, it will be appreciated that the disclosure may also be used in communication devices other than wireless devices, such as set top boxes, computers or similar wired devices. However, the disclosure does have particular advantages in systems where the bandwidth for delivering ESG information is limited as in wireless systems.

The term service as used herein is intended to cover services or content for the end user and services for the terminal. Services or content for the end user include TV channels, video and audio on demand, file delivery services, bulletin board and broadcast notification services like news feed, web-surfing in a controlled environment and similar services or content where data is presented to the user. Services for the terminal include cryptographic key retrieval when the content is subject to DRM, roaming, radio link budget optimisation, consumption reporting, device management etc

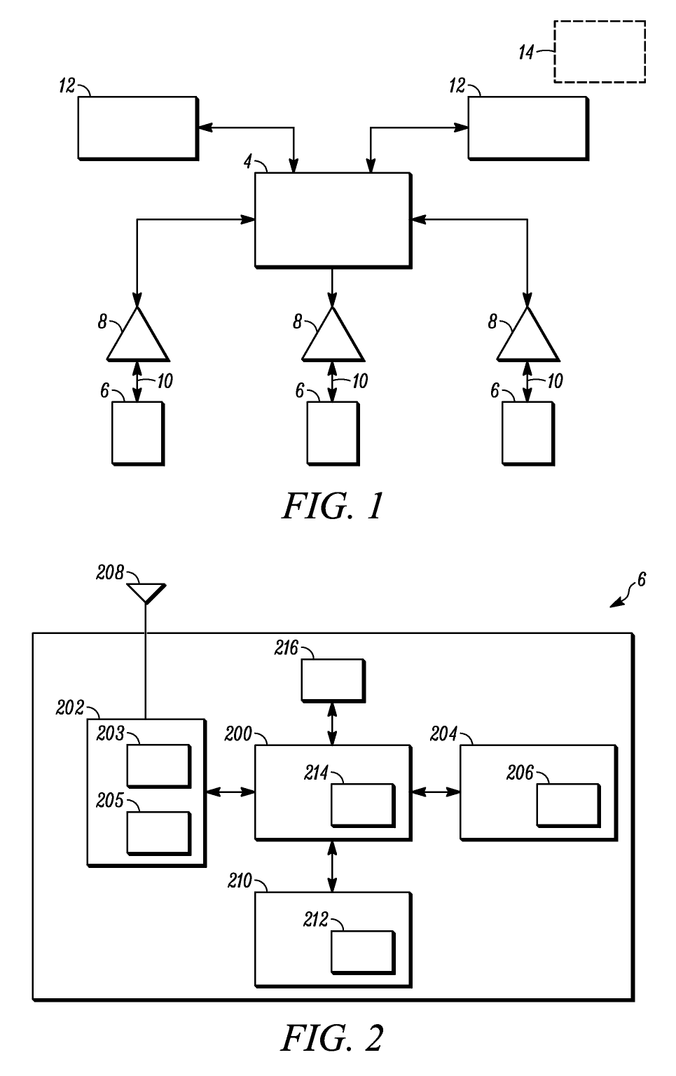

Referring firstly to FIG. 1, a communication system 2 comprises a network operator 4 communicating with wireless devices 6 via radio communication links 10 between the communication devices 6 and transceivers 8. The transceivers 8 are part of one or more communication networks and a single transceiver 8 may support one or more communication networks. In a UMTS communication network, the transceivers 8 are base stations.

The network operator 4 may generate its own services and ESGs which are available for users or subscribers to the network operator 4. Alternatively or additionally, the network operator 4 receives services and ESGs from at least one information source, such as service provider 12, which services the network operator 4 makes available for users or subscribers to the network operator 4. The network operator 4 may be a virtual network operator which leases ‘space’ on the transceivers 8 from another operator which owns the underlying network of transceivers 8. The services that are available to the user will in part depend on the user's subscription to the network operator 4.

Referring now also to FIG. 2 which is a partial schematic block diagram of an exemplary wireless device 6. As will be apparent to a skilled person, only those functional components of the wireless device that are necessary for an understanding of the disclosure have been shown and will be described. The wireless device 6 may be a portable or handheld or mobile telephone, a Personal Digital Assistant (PDA), a portable computer, portable television and/or similar devices.

The wireless device 6 comprises a processing unit 200 for configuration and control of the wireless device 6. The processing unit 200 is communicably coupled to a RF communication unit 202 which typically comprises a receiver 203, transmitter 205 (which may be separate elements or part of a transceiver device), a modulation/demodulation section (not shown), a coding/decoding section (not shown) as is well known in the art, and to a Man Machine Interface (MMI) 204. The MMI 204 includes elements such as a key pad, microphone, speaker, a display 206, for providing an interface between the wireless device 6 and the user of the wireless device 6. The RF communication unit 202 is coupled to an antenna 208.

The processing unit 200 may be a single processor or may comprise two or more processors carrying out all processing required for the operation of the wireless device 6. The number of processors and the allocation of processing functions to the processor is a matter of design choice for a skilled person. The wireless device 6 also has a program memory 210 in which is stored programs containing processor instructions for operation of the wireless device 6. The programs may contain a number of different program elements or sub-routines containing processor instructions for a variety of different tasks, for example, for: communicating with the user via the MMI 204; and processing signalling messages received from the transceivers 8. Specific program elements stored in program memory 210 include an ESG program element 212.

ESG information from at least one information source, which at least one information source may be the network operator 4, and/or one or more service providers 12, is received via the radio communication links 10 at the receiver 203 of the wireless device 6 via the antenna 208. The received ESG information is processed by the RF communication unit 202 and passed to the processing unit 200. The processing unit 200 processes the received ESG information according to the ESG program element 212 and the ESG is presented to the user on the display 206.

User preference data includes data from explicit user expression of preferences and interests, data based on previous user activity and also inferred preference data such as that generated by data mining, reasoning and/or inference from users with related interests and preferences. For example user preference data may indicate the topics the user is interested, the preferred language, preferred media format, preferred content genre (e.g. comedy, drama), specific people and named entities of interest (e.g. favourite actor, favourite football team), specific dislikes (e.g. never watches soap operas), time of day related preferences (e.g. always watches the news after 6:00 pm), type of information preferred (e.g. short video clips rather than long TV programmes). The user preference data may be stored in a user profile database represented by box 14 in FIG. 1 in the network part of the communication system 2, for example it may be part of the network operator 4, or a content provider 12 or another information source, or it may be stored in a user profile memory 214 in the wireless device 6. The user profile memory 214 is shown in FIG. 2 as being part of the processing unit 200 but may be separate to the processing unit 200.

A method of providing ESG information to a user in accordance with an embodiment of the disclosure will now be described.

In a first mode of operation and as performed in the known arrangements, the user preference data is consulted to determine what information is presented to the user in the ESG that is displayed on the display 206. When the user preference data is stored in the user profile database 14, a filtering operation is performed at the system side, for example in the network operator 4, on the information for all the services available to the user using the user preference data for the user from user profile database 14 so that only ESG information for the available services based on the user preference data (e.g. only ESG information for the available services which meet the interests which may be inferred from the available user preference data) is communicated to the wireless device 6 and presented to the user as user information. When the user preference data is stored in the user profile memory 214 in the wireless device 6, the processing unit 200 filters the information for all the services available to the user received at the receiver 203 using the user preference data from the memory 214 so that only ESG information for the available services based on the user preference data is presented to the user as user information.

In a second mode of operation, system information specified by the system, for example, by the network operator or the service provider 12, are combined with or inserted into the user information so that the user is presented with both the user information and the system information in an ‘almost’ personalised ESG. In an embodiment, the position of the system information is sited so that the layout of the user information or personalised ESG is not significantly disrupted. The personalised ESG and the system information may be combined on the system side, for example, by the network operator 4 or by the processing unit 200 of the wireless device 6.

The system information may include items that the network operator 4 or content provider 12 wants the user to see. These could be links to current or upcoming programmes, sponsored links, links to premium content, advertising links, links to subscribe to new services or other information specified by system, e.g. the network operator 4 or content provider 12.

The system information is displayed to the user on the display 206 with the personalised ESG at predetermined times for a predetermined duration. At other times, the personalised ESG is displayed without the system information according to the first mode of operation. The duration of displaying the system information with the personalised ESG information is less than the duration of displaying the personalised ESG information without the system information.

A timer unit 216 of the wireless device 6 times consecutive display periods in which information is displayed on the display and determines the predetermined times at which the system information is displayed with the personalised ESG during the second mode of operation. The timer unit 216 may be a separate element of the wireless device 6 as is shown in FIG. 2 or may be part of the processing unit 200. The timer unit 216 is arranged to select different predetermined times in consecutive display periods for displaying the system information with the personalised ESG so that it appears natural to the user and is somewhat random. An implementation of timer unit 216 includes a random number generator (not shown) and a counter (not shown). The counter counts each display period and the predetermined time at which the system information is displayed with the personalised ESG corresponds to when the count of the counter is equal to the random number generated by the random number generator.

The way in which the system information is combined with the personalised ESG in accordance with an embodiment of the disclosure is determined by the following variables:

(1) The proportion of personalised ESG compared to system information. This is a system defined parameter (B) and may vary between users. For example, the amount may vary based on the tariffs paid by the users. If the user is on a premium tariff, B may be 90% or more with 10% or less for system information. If the user is on a lower tariff, B may be 70% with and 30% for system information.

(2) The frequency (F) and spacing (S) of the combination of the system information with the personalised ESG (i.e. of the second mode of operation compared to the first mode of operation). Again these may vary between users and may depend on the tariffs paid by the users. Initially, the frequency parameter F and spacing parameter S are set for each user by the system (network operator). For example, F is 5 times per day with a mean spacing of S hours for premium tariff users and a higher frequency and lower spacing for lower tariff users. The actual interval between the predetermined times at which the combination of the system information with the personalised ESG is displayed are generated from a chosen distribution e.g. a normal distribution with mean S, and standard deviation calculated from knowing the target F.

(3) The duration of time (L) in which the combination of the system information with the personalised ESG is displayed. Again this duration may vary between users and may depend on the tariffs paid by the users. For example, the duration could be as short as a few seconds e.g. the user looks away and the display updates back to the personalised ESG by the time they look again or as long as several minutes.

As the user interacts with the system, if there is evidence of non-acceptance of the display of the combination of the system information with the personalised ESG in the second mode of operation, F and L can be decreased (and S increased), and also B may be increased. If the user responds well and starts accepting the items or services identified by the system information, F and L may be increased, and B decreased. In an embodiment, the user preference data may be updated to include the additional items identified by the system information that the user has selected from the display.

The following working example provides a further illustration of an embodiment of the disclosure.

An operator is offering personalised ESGs e.g. for an on-line video streaming service. Users X and Y are standard subscribers, paying $19.99 per month for mainstream content. A premium service is available at $29.99 per month.

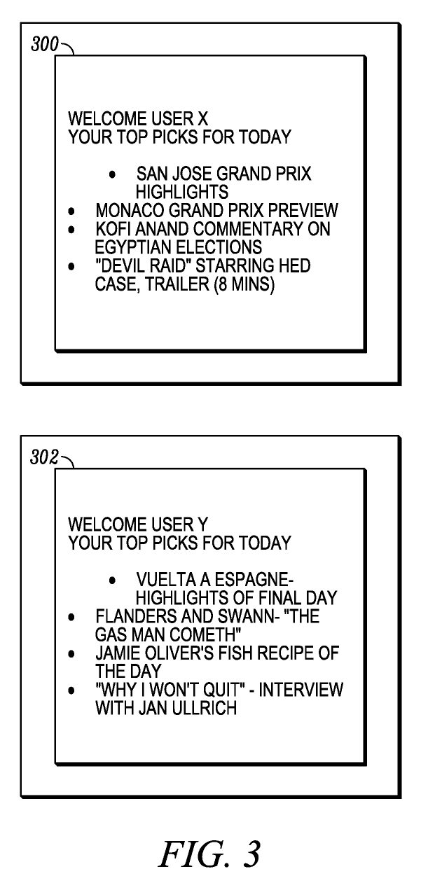

User X has expressed preferences for motor racing, action movie previews, and interviews with international politicians and the user preference data for user X includes these preferences. User Y has expressed preferences for cookery clips, cycling, and archive comedy segments and the user preference data for user X includes these preferences. The displays 300 and 302 of the personalised ESGs for each user X, and Y are shown in FIG. 3.

The communication system 2, in this particular example the service providers, sets B to be 90% i.e. 90% of the combination of the system information and the personalised ESG (‘almost’ personalised ESG) will always be based on the user preference data. The remaining 10% are links to material specified by the service provider, for example to premium material the service provider wants to tempt the users to try. If they get interested in the premium material, they will be offered the chance to upgrade their service package. Today's premium material is an interview with singing star Beyonce, clips of French footballer Thierry Henry training for a football World Cup qualifier match, and live streaming from the Space Shuttle launch.

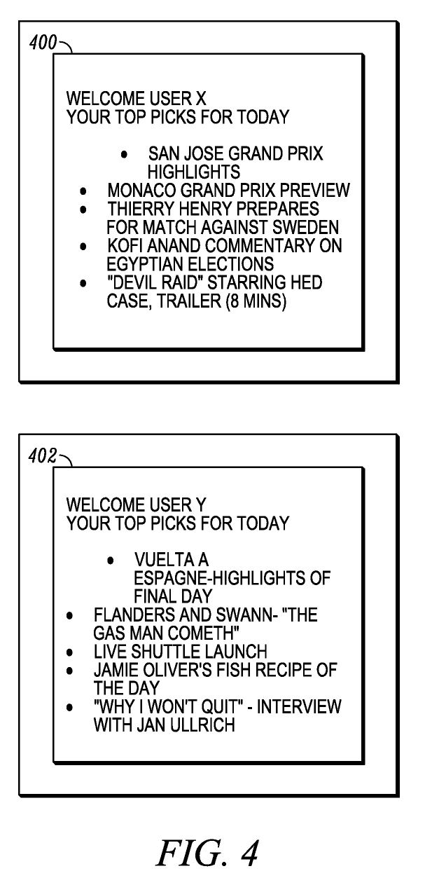

The service provider selects F to be 5 times per day, with a display length L of 2 minutes. The mean spacing S will be 2 hours, but the actual predetermined times at which the ‘almost’ personalised ESG are displayed are randomised so that the user cannot anticipate when the additional recommendations will be presented. The displays 400 and 402 of the ‘almost’ personalised ESGs for each user X, and Y are shown in FIG. 4.

As shown in FIG. 4, sports content is presented close to the user's preferred sports content, news content next to user preferred news content etc. In this way the layout of the personalised ESG display is not disturbed significantly. Therefore, sometimes when the user looks at their display 206 to see what streamed content they could watch, they will see the extra system defined recommendations.

In an embodiment, an explanation of recommendations defined by the system information may be provided so that users can ask why they have been recommended a certain item or service. Usually the user finds explanations such as “we recommended this because you expressed an interest in <topic> in your profile”, but sometimes it will be the case that the recommendation comes from the ‘almost’ personalised ESG in which case the user may be informed that the recommendation was made to offer them some new content or service (in the interests of content discovery).

In an embodiment, it may be possible to disable the second mode of operation so that a user is only presented with personalised ESGs.

In summary, the present disclosure provides a means to generate and display to a user an ‘almost’ personalised ESG which includes system information specified by the communication system as well as the user information based on user preference data at random times. The personalised ESG is displayed to the user at other times. This enables the communication system, for example, the network operator or the service provider, to retain some control of the ESG information being presented to the user at certain times.

An advantage of the communication system retaining some control of the ESG information being presented to the user is that the user can benefit from the discovery of content outside their usual areas of interest. Furthermore, the ‘almost’ personalised ESG is only presented at certain times with the personalised ESG being presented at other times. This should avoid the user having the impression of being bombarded with advertising material.

Although embodiments of disclosure have been described with respect to ESGs, it will be appreciated that the present disclosure relates to any information in any format which information provides details of the services available to a user. For example, the disclosure also applies to a list of available services in HTML format obtained via a web browser.

1. A communication device for operating in a communication system comprising:
a receiver for receiving information from at least one information source of the communication system; and
a display coupled to the receiver for displaying information to a user of the communication device, wherein the communication device is arranged in operation and based on the received information to display on the display at predetermined times system information specified by the communication system with user information based on user preference data and at other times to display the user information without the system information.

2. A communication device according to claim 1, wherein the system information is based on the user preference data.

3. A communication device according to claim 1, wherein the system information is inserted into the user information for display on the display.

4. A communication device according to claim 1, wherein the communication device is arranged in operation to display at predetermined times and for first predetermined durations the system information with the user information and at other times to display the user information without the system information for second predetermined durations, the first predetermined durations being shorter than the second predetermined durations.

5. A communication device according to claim 4, wherein a value of the first predetermined duration is variable.

6. A communication device according to claim 4, wherein a value of the first predetermined duration for a user is variable according to a tariff paid by the user.

7. A communication device according to claim 1, wherein an amount of system information displayed with the user information at the predetermined times compared to the amount of user information is variable.

8. A communication device according to claim 1, wherein an amount of system information displayed with the user information at the predetermined times compared to the amount of user information is variable according to a tariff paid by the user.

9. A communication device according to claim 1, wherein the communication device further comprises a timer unit for timing consecutive display periods in which information is displayed on the display, and for determining a predetermined time during a display period at which the system information is displayed with the user information.

10. A communication device according to claim 9, wherein the timer unit is arranged such that different predetermined times are selected in consecutive display periods for displaying the system information with the user information.

11. A communication device according to claim 1, wherein a frequency at which system information is displayed with the user information at the predetermined times is variable.

12. A communication device according to claim 1, wherein a frequency at which system information is displayed with the user information at the predetermined times is variable according to a tariff paid by the user.

13. A communication device according to claim 1, further comprising a memory for storing user preference data and a processing unit for filtering the received information based on the user preference data to provide at least one of the user information and the system information.

14. A communication device according to claim 1, wherein user preference data are stored in an information source in the communication system and wherein the information received at the receiver includes the system information and the user information.

15. A communication system comprising;
a communication device; and
at least one information source for providing information to the communication device,
wherein the communication device comprises:
a receiver for receiving information from the at least one information source; and
a display coupled to the receiver for displaying information to a user of the communication device, wherein the communication device is arranged in operation and based on the received information to display on the display at predetermined times system information specified by the communication system with user information based on user preference data and at other times to display the user information without the system information

16. A communication system according to claim 15, wherein one of the at least one information source comprises a database for storing the user preference data and wherein at least one information source is arranged to provide the user information to the communication device.

17. A communication system according to claim 16, wherein at least one information source is arranged to provide the system information based on the user preference data to the communication device.

18. A communication system according to claim 15, wherein a first information source provides the user information and a second information source provides the system information.

19. A method of providing information to a user on a display of a communication device operating in a communication system, the method comprising the steps of:
receiving information from at least one information source of the communication system;
displaying based on the received information at the display at predetermined times system information specified by the communication system with user information based on user preference data; and
displaying based on the received information at the display at other times the user information without the system information.

20. A communication device for operating in a communication system including at least one information source for providing ESG information to the communication device, the communication device comprising:
a receiver for receiving ESG information from at least one information source of the communication system;
a display coupled to the receiver for displaying ESG information to a user of the communication device; and
a processing unit coupled to the receiver and the display, wherein the processing unit is arranged in operation and based on the received ESG information to:
at predetermined times, display on the display system ESG information specified by at least one information source inserted into user ESG information based on user preference data; and
at other times, display the user ESG information without the system ESG information.
